(19) United States
(12) Patent Application Publication
(10) Pub. No.: US 2009/0048745 A1
(43) Pub. Date: Feb. 19, 2009

(54) FLEXIBLE FUEL VARIABLE BOOST HYBRID POWERTRAIN

(75) Inventors: KO-JEN WU, TROY, MI (US); JAMES C. ELMSLIE, OXFORD, MI (US); JIAN JUN ZHANG, ROCHESTER, MI (US)

Correspondence Address: VIVACQUA LAW, PLLC, 455 East Eisenhower Parkway, Suite 11, ANN ARBOR, MI, 48108, US

(73) Assignee: GM GLOBAL TECHNOLOGY OPERATIONS, INC., DETROIT, MI (US)

(21) Appl. No.: 12/031,821

(22) Filed: Feb. 15, 2008

Related U.S. Application Data
(60) Provisional application No. 60/956,537, filed on Aug. 17, 2007.

(51) Int. Cl. B60W 10/02

(52) U.S. Cl. 701/51; 477/115

(57) ABSTRACT

The present invention provides a flexible fuel, spark ignition, variable boost, hybrid powertrain having a supercharger or a turbocharger. In a first embodiment, a spark ignition, internal combustion engine includes a supercharger driven by the engine output through a variable speed drive. A hybrid transmission having an internal electric motor/generator provides supplemental power. A plurality of sensors including a fuel sensor provide data to a master engine controller which controls the operation of a transmission controller, the variable speed supercharger, the fuel supply and the ignition system. In a second embodiment, the motor/generator is associated with the supercharger and is connected therewith through a variable speed drive and also connected to the engine output. In a third embodiment, the supercharger is replaced with a turbocharger.

### CROSS-REFERENCE TO RELATED APPLICATIONS

This application claims the benefit of U.S. Provisional Application No. 60/956,537, filed on Aug. 17, 2007. The disclosure of the above application is incorporated herein by reference.

### FIELD

The present disclosure relates to a flexible fuel, variable boost, hybrid powertrain and more particularly to a flexible fuel, variable boost, hybrid powertrain having an internal combustion engine including either a supercharger or a turbocharger.

### BACKGROUND

The statements in this section merely provide background information related to the present disclosure and may or may not constitute prior art.

Spark ignition, internal combustion powertrains, particularly those configurations utilized in passenger cars and light trucks, have been the subject of extensive development effort. One of the more recent results of such effort encompasses hybrid powertrains which may be broadly defined as powertrains utilizing both an internal combustion engine and an electric motor/generator, storage batteries and a controller for controlling the power sources and integrating their outputs with the operation of an automatic transmission.

Another relatively recent development are flexible fuel, spark ignition internal combustion engines. Such engines operate on both conventional gasoline and gasoline—ethanol (grain alcohol) blends containing, for practical reasons, as much as 85 percent ethanol which is commonly referred to as E85. Aside from the lower cost of ethanol based fuels and the larger issue of foreign oil dependency, engines operating on E85 and other blends have better knock tolerance when operating under wide open throttle or full load conditions than the same engine operating on gasoline. Nonetheless, such improved operation is often compromised because of the requirement that the engine be capable of operating on various fuels and blends of fuels.

Given the history of the development of the spark ignition internal combustion engine, it is apparent that improvements will continue and the present invention is directed to such an improvement.

### SUMMARY

The present invention provides a flexible fuel, spark ignition, variable boost, hybrid powertrain having a supercharger or a turbocharger. In a first embodiment, a spark ignition, internal combustion engine includes a supercharger driven by the engine output through a variable speed drive. A hybrid transmission having an internal electric motor/generator provides supplemental power. A plurality of sensors including a fuel sensor provide data to a master engine controller which controls the operation of a transmission controller, the variable speed supercharger, the fuel supply and the ignition system.

In a second embodiment which is similar in most respects to the first embodiment, the motor/generator is associated with the supercharger and is connected therewith through a variable speed drive and also connected to the engine output. In a third embodiment, the supercharger is replaced with a turbocharger.

Further objects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic illustration of a first embodiment of a flexible fuel, variable boost, supercharged, hybrid powertrain according to the present invention;

FIG. 2 is a diagrammatic illustration of a second embodiment of a flexible fuel, variable boost, supercharged, hybrid powertrain according to the present invention;

FIG. 3 is a diagrammatic illustration of a third embodiment of a flexible fuel, variable boost, turbocharged, hybrid powertrain according to the present invention; and

FIG. 4 is a chart comparing the typical fuel consumption of a turbocharged, spark ignition, internal combustion engine with a turbocharged, spark ignition, internal combustion engine incorporating a motor/generator device.

### DETAILED DESCRIPTION

The following description is merely exemplary in nature and is not intended to limit the present disclosure, application, or uses.

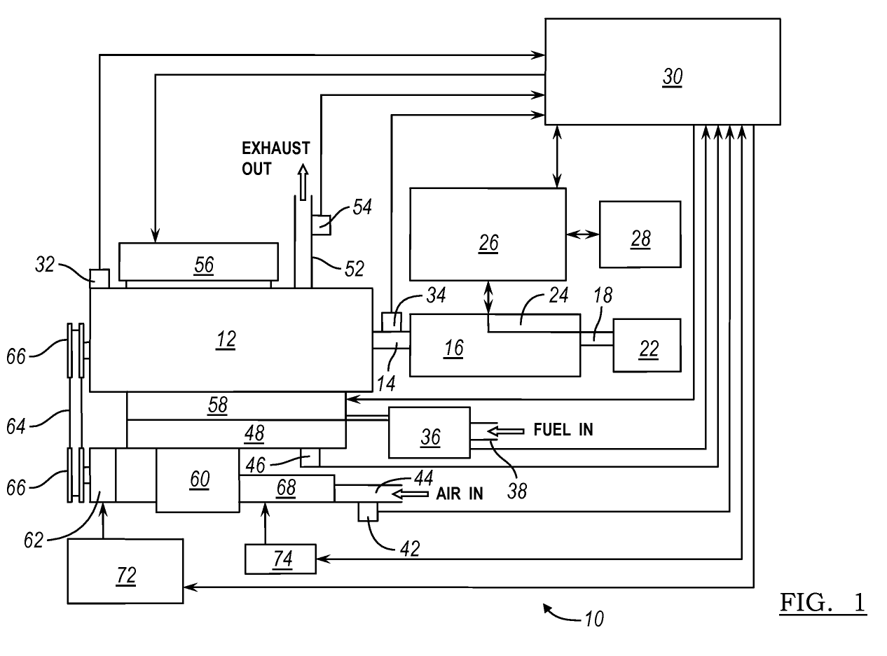

With reference to FIG. 1, a first embodiment of a flexible fuel, spark ignition, variable boost, supercharged, hybrid powertrain according to the present invention is illustrated and generally designated by the reference number 10. The flexible fuel hybrid powertrain 10 includes an internal combustion engine 12 typically having four, six or eight pistons and cylinders. The pistons are coupled to a crankshaft or output shaft 14 which directly drives a multiple speed, typically automatic, hybrid transmission 16. The hybrid transmission 16 includes, for example, a plurality of planetary gear sets, clutches and brakes which provide a multiple, sequential gear or speed ratio output to a prop shaft 18 and a final drive arrangement 22 that may include at least one differential, axles and tire and wheel assemblies (all not illustrated). The hybrid transmission 16 also includes a motor/generator 24 that is connected to the power flow path through the hybrid transmission 16 and functions as either a motor to supply additional energy to the powertrain 10 or as a generator to recover energy during vehicle deceleration. The hybrid transmission 16 and the motor/generator 24 are controlled by and provide feedback signals to a transmission controller 26 which controls the operation of the hybrid transmission 16 and supplies electrical energy from a high capacity battery 28 to the motor/generator 24 when additional power is required and directs electrical energy from the motor/generator 24 to the battery 28 when such energy is available during, for example, deceleration of the vehicle.

The transmission controller 26 is, in turn, under the control of a master engine controller 30. The master engine controller 30 receives a plurality of signals or data from various sensors and controllers, includes processors, memory, look up tables and software and provides a plurality of signals and data to various operators and controllers thereby controlling overall operation of the engine 12. A camshaft angle sensor 32 provides a signal or data to the engine controller 30 regarding the rotational (angular) position of the camshaft. A crankshaft angle sensor 34 provides a signal or data to the engine controller 30 regarding the rotational (angular) position of the crankshaft 14. A fuel sensor 36 provides a signal or data to the engine controller 30 regarding the type of fuel, i.e., gasoline, E85 or another blend of gasoline and ethanol, currently being supplied to the internal combustion engine 12 in a fuel line 38. Alternatively, the master engine controller 30 may contain an algorithm which determines the type or blend of fuel based upon sensed engine and operating conditions.

A mass air flow sensor (MAF) 42 residing in an air inlet duct 44 provides a signal or data to the engine controller 30 regarding the mass air flow currently being provided to the engine 12. A manifold air pressure (MAP) sensor 46 is disposed in an intake manifold 48 and provides a signal or data to the engine controller 30 regarding the current air pressure within the intake manifold 48. An exhaust manifold 52, secured to the engine 12, includes an exhaust gas (oxygen) sensor 54 which provides a signal or data to the engine controller 30 regarding the amount of oxygen in the exhaust gasses of the engine 12. The exhaust manifold 52 routes exhaust gas to an exhaust system (not illustrated).

The master engine controller 30 provides signals to and controls a spark ignition system 56 and a fuel injection system 58 which is disposed between the intake manifold 48 and the internal combustion engine 12. The fuel injection system 58 may be either port or direct (in cylinder) injection type.

A supercharger 60 provides air at or above atmospheric pressure to the intake manifold 48 and is driven through a variable speed drive assembly 62 by a belt 64 disposed about pulleys 66 (or other power transfer assembly) on the variable speed drive assembly 62 and the crankshaft 14 of the internal combustion engine 12. The variable speed drive assembly 62 may be either a continuously variable type or a stepped or two speed configuration providing direct drive and a fixed speed increase. Thus, the variable speed drive assembly 62 may include a CVT or planetary gear type drive assembly which is controlled electrically or hydraulically. In either case, the typical maximum speed ratio increase will be on the order of 1 to 2.5 to 1 to 4.0 although a lower minimum (speed increase) ratio and/or a higher maximum (speed increase) ratio may be appropriate or dictated by certain applications. The inlet (suction) side of the supercharger 60 is connected to the air inlet duct 44 downstream of a throttle assembly 68 and the outlet (pressure) side of the supercharger 60 is connected to the intake manifold 48 in which the manifold air pressure sensor 46 resides.

The supercharger 60 and, more specifically, the variable speed drive assembly 62 is controlled by a supercharger drive controller 72 which, in turn, is controlled by signals or data from the master engine controller 30. The throttle assembly 68 is controlled by an electronic throttle control assembly 74 which is also controlled by signals or data from the master engine controller 30.

In operation, torque management of the flexible fuel hybrid powertrain 10 requires coordination of the internal combustion engine 12 and the motor/generator 24 based on the fuel being utilized, the state of the engine 12, the state of the transmission 16, the state of stored electrical energy in the battery 28 and the torque demand of the driver.

When ethanol is used, and with the variable boost flexibility provided by the variable boost supercharger 60, torque demands will be primarily satisfied by the internal combustion engine 12 alone. Accordingly, the hybrid transmission 16 will primarily be used to enable starts and stops and achieve deceleration fuel cutoff and braking regeneration, with only occasional torque assist, i.e., activation of the motor/generator 24, under conditions of poor engine efficiency.

When the torque output of the internal combustion engine 12 is sufficiently high, the speed of the supercharger 60 is determined by the type of fuel and is controlled by adjusting the variable speed drive assembly 62: higher for ethanol and ethanol blends and lower for gasoline. The duration of fuel injection pulses by the fuel injection system 58 and the spark timing of the ignition system 56 are also adjusted to compensate for the extra air flow and the specific fuel type.

If the desired torque can be supplied by the internal combustion engine 12 alone, the motor/generator 24 in the hybrid transmission 16 can remain inactive. Otherwise, the transmission controller 26 and, in certain applications, the master engine controller 30, may be programmed to activate the motor/generator 24 to complement the internal combustion engine 12 to meet the desired performance and driveability goals while maximizing fuel economy.

Finally, the master engine controller 30 will typically generate signals or commands to the transmission controller 26 to adjust the shift point schedule of the hybrid transmission 16 and the lockup schedule of a torque converter (not illustrated) to optimize powertrain and vehicle performance, driveability and fuel economy.

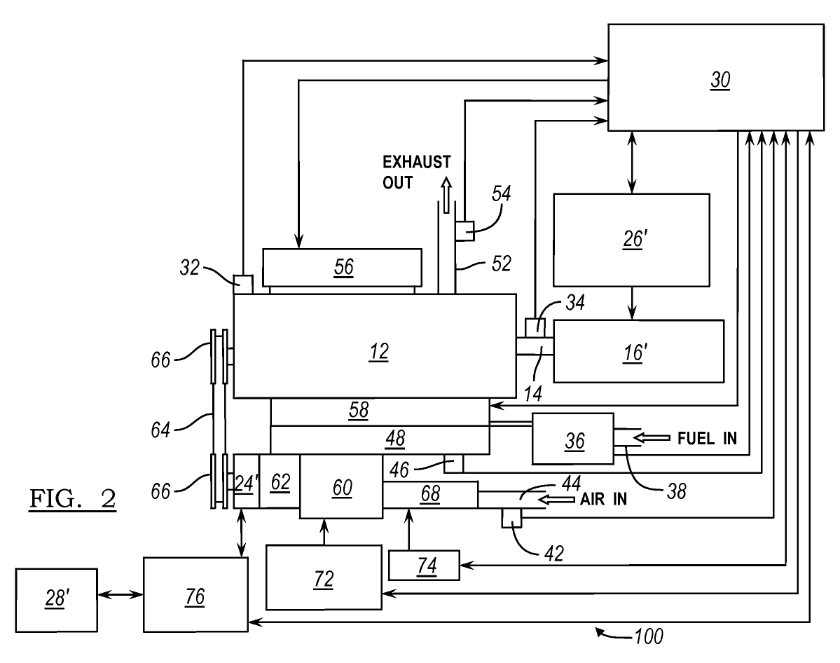

Referring now to FIG. 2, a second embodiment of a flexible fuel, variable boost, supercharged, hybrid powertrain according to the present invention is illustrated and generally designated by the reference number 100. The second embodiment hybrid powertrain 100 is essentially the same as the first embodiment hybrid powertrain 10 except that the location of the motor/generator 24 has been removed from the hybrid transmission 16 and associated with the supercharger 60 and its variable speed drive assembly 62.

Thus, the second embodiment hybrid powertrain 100 includes an internal combustion engine 12 having a crankshaft 14 driving an automatic, multiple speed transmission 16′ which includes, typically and in accordance with conventional practice, a plurality of planetary gear sets, clutches and brakes and an output shaft 18 which drives a final drive arrangement 22 (both illustrated in FIG. 1).

The second embodiment hybrid powertrain 100 also includes a transmission controller 26′, a master engine controller 30, a camshaft angle sensor 32, a crankshaft angle sensor 34, a fuel sensor 36 disposed in a fuel line 38, a mass air flow (MAF) sensor 42 disposed in an air inlet duct 44 and a manifold air pressure (MAP) sensor 46 disposed in an intake manifold 48.

An exhaust manifold 52 includes an exhaust gas (oxygen) sensor 54. A spark ignition system 56 and a fuel injection system 58 which may be either port or direct injection type both receive data or signals from and are controlled by the master engine controller 30.

A supercharger 60 which is connected on its inlet (suction) side to the inlet air duct 44 downstream of a throttle assembly 68 and on its outlet (pressure) side to the intake manifold 48 includes a variable speed drive assembly 62 which is driven in tandem with a motor/generator 24′ from the crankshaft 14 of the internal combustion engine 12 through a belt 64 and a pair of pulleys 66 or other power transfer assembly. As described above, the variable speed drive assembly 68 may be either a continuously variable or stepped or two speed device providing direct drive as well as a speed increase of up to 2.5 to 4.0 to one or more or less depending upon the application. Selection and control of the drive ratio of the variable speed drive assembly 62 is achieved by a supercharger drive controller 72 which is, in turn, under the control of the master engine controller 30.

A motor/generator controller 76 supplies electrical energy from a high capacity battery 28′ to the motor/generator 24′ when additional torque is required and directs electrical energy from the motor/generator 24′ to the battery 28 when such energy is available during, for example, deceleration of the vehicle.

It will be understood that operation of the second embodiment of the flexible fuel, variable boost, supercharged, hybrid powertrain 100 is essentially the same as operation of the first embodiment of the hybrid powertrain 10. The significant distinction between these embodiments is not operational but rather structural in that the motor/generator 24′ is associated with the variable speed drive assembly 62 of the supercharger 60 and is driven through a belt 64 from a pulley 66 on the crankshaft 14 of the internal combustion engine 12 in the second embodiment 100 whereas the motor/generator 24 is a integral component of the automatic transmission 16 in the first embodiment powertrain 10.

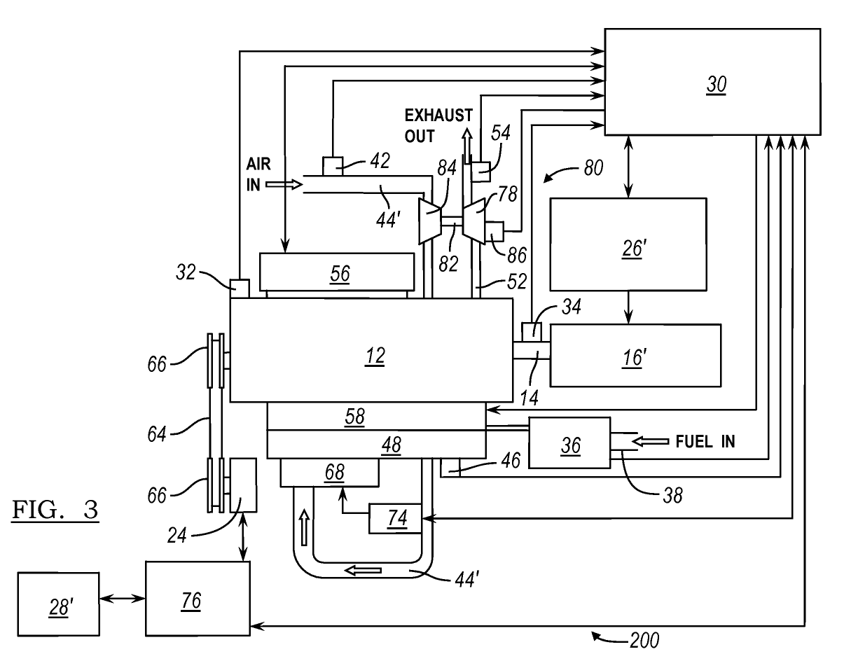

Referring now to FIG. 3, a third embodiment of a flexible fuel, variable boost, turbocharged, hybrid powertrain according to the present invention is illustrated and generally designated by the reference number 200. In the third embodiment hybrid powertrain 200, the motor/generator 24′ is driven and drives the crankshaft 14 of the internal combustion engine 12 through a belt 64 as it is configured in the second embodiment hybrid powertrain 100 rather than being a component of the automatic transmission 16 in the first embodiment powertrain 10. Additionally, the supercharger 60, utilized in both the first and second embodiment powertrains 10 and 100, is replaced by a turbocharger in the second embodiment hybrid powertrain 200.

Accordingly, the second embodiment hybrid powertrain 200 includes an internal combustion engine 12 having a crankshaft 14 driving an automatic, multiple speed transmission 16′ which includes, typically and in accordance with conventional practice, a plurality of planetary gear sets, clutches and brakes and an output shaft 18 which drives a final drive arrangement 22 (both illustrated in FIG. 1).

The third embodiment hybrid powertrain 200 also includes a transmission controller 26′, a master engine controller 30, a camshaft angle sensor 32, a crankshaft angle sensor 34, a fuel sensor 36 disposed in a fuel line 38, a mass air flow (MAF) sensor 42 disposed in an air inlet duct 44′ near its mouth and a manifold air pressure (MAP) sensor 46 disposed in an intake manifold 48.

An exhaust manifold 52 includes an exhaust gas (oxygen) sensor 54. A spark ignition system 56 and a fuel injection system 58 which may be either port or direct injection type both receive data or signals from and are controlled by the master engine controller 30. Between the end of the air duct 44′ and the intake manifold 48 is a throttle assembly 68 which is controlled by an electronic throttle control 74 which, in turn, is controlled by the master engine controller 30.

Residing in the stream of exhaust gasses in the exhaust manifold 52 is a drive or exhaust turbine 78 of a turbocharger 80. The drive turbine 78 absorbs a portion of the kinetic energy of the exhaust gasses and rotates a shaft 82 which is coupled to a driven or inlet air compressor 84 which resides in the inlet air duct 44′. Operation of the turbocharger 80, i.e., whether and to what extent it is active and rotated by the exhaust gasses from the internal combustion engine 12 or inactive may be controlled by a conventional wastegate 86 or by adjusting a variable geometry or flow device, both of which are controlled by the master engine controller 30.

A motor/generator 24′ is driven by and drives the crankshaft 14 of the internal combustion engine 12 through a belt 64 and a pair of pulleys 66 or a similar power transfer assembly. The motor/generator 24′ is controlled by a motor/generator controller 76 which supplies electrical energy from a high capacity battery 28′ to the motor/generator 24′ when additional torque is required and directs electrical energy from the motor/generator 24′ to the battery 28′ when such energy is available during, for example, deceleration of the vehicle.

Operation of the third embodiment hybrid powertrain 200 is essentially the same as that of the second embodiment hybrid powertrain 100, especially with regard to the motor/generator 24′, the motor/generator controller 76 and the battery 28′. The turbocharger 80, since the degree of boost is controllable by the engine controller 30 through operation of the wastegate 86 or other boost adjusting means, provides variable boost which can therefore be matched or adjusted to the fuel and operating conditions to optimize performance and fuel economy in accordance with the operating parameters discussed above with regard to the first embodiment hybrid powertrain 10.

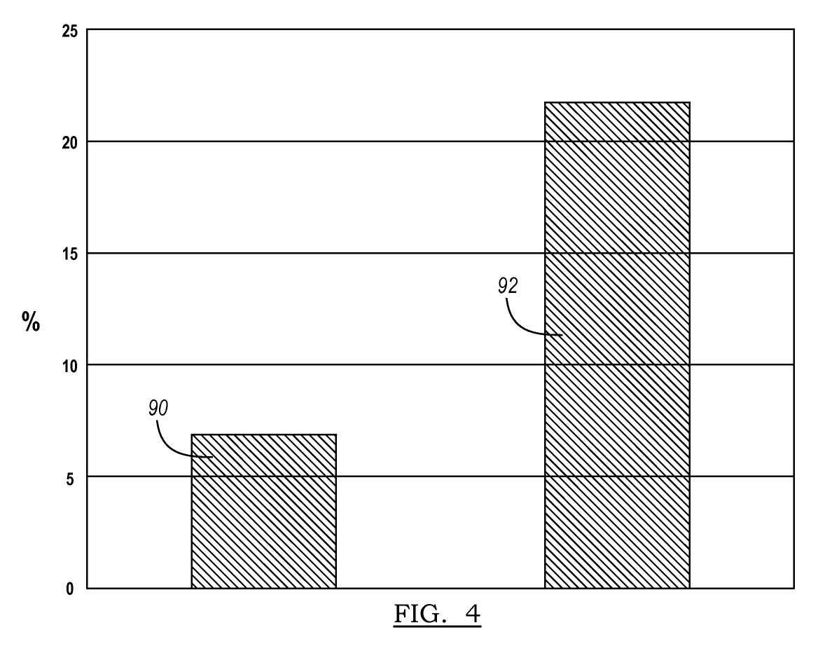

Referring now to FIG. 4, a chart illustrates predicted fuel economy for gasoline fuel in two spark ignition, turbocharged, internal combustion engines. The Y-axis presents unadjusted fuel economy improvement in percent wherein the baseline is a naturally aspirated engine. The column 90 to the left represents the fuel economy of a turbocharged engine. The column 92 to the right represents a turbocharged engine operating in conjunction with a motor/generator unit. It will be appreciated that the addition of the motor/generator unit improves fuel economy by approximately 15 percent.

The description of the invention is merely exemplary in nature and variations that do not depart from the gist of the invention are intended to be within the scope of the invention. Such variations are not to be regarded as a departure from the spirit and scope of the invention.

What is claimed is:

1. A flexible fuel, hybrid powertrain comprising, in combination,
an internal combustion engine having an intake manifold and a first output,
means for increasing air pressure in said intake manifold,
an adjustable speed drive assembly for driving said air pressure increasing means,
a plurality of sensors including at least a fuel sensor, a mass air flow sensor and an intake manifold pressure sensor,
a motor/generator having a second output and a controller,
a transmission driven by said first and second outputs and a transmission controller,
a master engine controller having a plurality of inputs for receiving data from said plurality of sensors, an output for controlling said adjustable speed drive assembly and communication links to said controller and said transmission controller.

2. The flexible fuel, hybrid powertrain of claim 1 wherein said means for increasing air pressure is a supercharger.

3. The flexible fuel, hybrid powertrain of claim 1 wherein said means for increasing air pressure is a turbocharger.

4. The flexible fuel, hybrid powertrain of claim 1 wherein said adjustable speed drive assembly includes a speed increasing portion and a control portion for receiving said output from said master engine controller.

5. The flexible fuel, hybrid powertrain of claim 1 further including an electronic throttle control controlled by said master engine controller.

6. The flexible fuel, hybrid powertrain of claim 1 further including a wastegate controller by said master engine controller.

7. The flexible fuel, hybrid powertrain of claim 1 further including a fuel injection system and a spark ignition system controlled by said master engine controller.

8. A flexible fuel, hybrid powertrain comprising, in combination,
an internal combustion engine having an intake manifold and a first output,
a supercharger having an output in fluid communication with said intake manifold,
an adjustable speed drive assembly for driving said supercharger,
a plurality of sensors including at least a fuel sensor, a mass air flow sensor and an intake manifold pressure sensor,
a motor/generator having a second output and a controller,
a transmission driven by said first and second outputs and a transmission controller,
a master engine controller having a plurality of inputs for receiving data from said plurality of sensors, an output for controlling said adjustable speed drive assembly and communication links to said controller and said transmission controller.

9. The flexible fuel, hybrid powertrain of claim 8 further including a crankshaft angle sensor and an oxygen sensor.

10. The flexible fuel, hybrid powertrain of claim 8 further including a fuel injection system and a spark ignition system controlled by said master engine controller.

11. The flexible fuel, hybrid powertrain of claim 8 further including an electronic throttle control controlled by said master engine controller.

12. The flexible fuel, hybrid powertrain of claim 8 wherein said adjustable speed drive assembly includes a speed increasing portion and a control portion for receiving said output from said master engine controller.

13. The flexible fuel, hybrid powertrain of claim 8 wherein said adjustable speed drive assembly said adjustable speed drive assembly includes one of a two speed and a continuously variable type.

14. The flexible fuel, hybrid powertrain of claim 8 wherein said adjustable speed drive assembly increases speed in a ratio of between about 1 to 2.5 to 1 to 4.0.

15. A flexible fuel, hybrid powertrain comprising, in combination,
an internal combustion engine having an intake manifold and a first output,
a turbocharger having an output in fluid communication with said intake manifold,
an adjustable speed drive assembly for driving said turbocharger,
a plurality of sensors including at least a fuel sensor, a mass air flow sensor and an intake manifold pressure sensor,
a motor/generator having a second output and a controller,
a transmission driven by said first and second outputs and a transmission controller,
a master engine controller having a plurality of inputs for receiving data from said plurality of sensors, an output for controlling said adjustable speed drive assembly and communication links to said controller and said transmission controller.

16. The flexible fuel, hybrid powertrain of claim 15 further including a wastegate controller by said master engine controller.

17. The flexible fuel, hybrid powertrain of claim 15 further including an electronic throttle control controlled by said master engine controller.

18. The flexible fuel, hybrid powertrain of claim 15 further including a fuel injection system and a spark ignition system controlled by said master engine controller.

19. The flexible fuel, hybrid powertrain of claim 15 wherein said adjustable speed drive assembly includes a speed increasing portion and a control portion for receiving said output from said master engine controller.
